(19) United States
(12) Patent Application Publication
(10) Pub. No.: US 2009/0164959 A1
(43) Pub. Date: Jun. 25, 2009

(54) Layout design device and layout design method of semiconductor integrated circuit

(75) Inventor: Tadashi Warikai, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,824

(22) Filed: Dec. 17, 2008

(30) Foreign Application Priority Data
Dec. 19, 2007 (JP) 2007-327136

(51) Int. Cl. G06F 17/50

(52) U.S. Cl. 716/10

(57) ABSTRACT

A layout design device includes a calculation processing portion that calculates a degree of wire congestion of each layer based on a pre-wiring design data to form a desired wiring structure in each layer, a selection processing portion that selects one area from a plurality of areas as a selection area, and an adding processing portion that generates a post-addition design data by adding a design data which connects the power supply and ground including layer and the (n−1)th layer or the (n+1)th layer to the pre-wiring design data. A degree of wire congestion of the selection area of nth layer is lower than that of (n−1)th layer or (n+1)th layer, the selection processing portion selects a power supply and ground including layer which is a lower layer of the (n−1)th layer or an upper layer of the (n+1)th layer and has a power supply or a ground. A wiring process and a metal generating process are performed based on the post-addition design data.

### BACKGROUND

1. Field of the Invention

This invention relates to a layout design device and layout design method for a semiconductor integrated circuit.

2. Description of Related Art

Decrease of yield in manufacturing and large increase of a design period have become serious with the miniaturization and the increase in scale of a semiconductor integrated circuit. Therefore, in a layout design of a semiconductor integrated circuit, there is a need for increasing yield and shortening a design period.

In general, it is possible to increase yield in manufacturing by planarizing a metal in each layer. Specifically, in a layout design, after transistors are arranged and wired, a metal is formed for planarizing. In a formation of a metal for planarizing, criterion of data rate of the formed metal is decided. This process prevents yield from decreasing by forming the metal so as to meet the criterion.

A forming method of metal includes a floating method and a string method. In the floating method, a metal is formed without being directly connected to a power supply and ground. On the other hand, in the string method, a metal is formed with direct connection to a power supply potential or ground potential.

When the metal is formed in the floating method, the formed metal has a midpoint potential. Therefore a delay variation occurs by cross talk and this has a bad influence on the circuit operation. Furthermore, if a circuit is to operate at high-speed, the accuracy of this delay calculation is important. However, if the midpoint potential exists, the accuracy of the delay calculation becomes low.

On the other hand, when the metal is formed in the string method, the formed metal connects to a power supply potential or ground potential. Therefore a potential of the formed metal becomes constant, and a delay variation does not occur from cross talk. So, in general, the metal is formed by the string method.

It is necessary that a power supply and a ground are provided preliminarily to form a metal by the string method. However, since the minimum amounts of a power supply potential and a ground potential need to be supplied in practice, some of the power supply bus or ground bus might be omitted in a design process in order to secure wiring capability. In this case, there are no power supply bus and ground bus in some layers or areas, and so it is difficult to form a metal by the string method in these layers or areas. A metal forming process is performed at the last stage of a layout design. Therefore if the data rate of a formed metal is deficient and the metal cannot be connected to a power supply potential, the layout should be modified, and this increases a layout design period.

A technique in which a metal in each layer of a semiconductor integrated circuit is planarized by forming a metal (dummy pattern) in the area where metals are nondense in each layer of a semiconductor integrated circuit is disclosed in Japanese Unexamined Patent Application Publication No. 2002-076118 (Ito).

FIG. 30 is a flow chart showing method for forming a metal in Ito. As shown in FIG. 30, firstly, after layout design is finished, design data which includes arrangement of transistors, wire connections, and so on, is input into a layout design device as stream data (step S301).

Secondly, the layout design device forms a metal called a “dummy pattern” (step S302). At this time, the dummy pattern is not connected to a power supply potential or a ground potential. Further, the dummy pattern is formed in the area where metals are nondense in each layer. The dummy pattern formation is performed in view of rules of design criterion.

Next in the design sequence, it is decided whether the power supply wire and the dummy pattern are connected through a via (step S303). At this time, if there is a signal wire between a power supply line and the dummy pattern or there is no power supply wire on the dummy pattern, the dummy pattern is not connected to a power supply wire.

Next, it is decided whether a ground wire and the dummy pattern are connected through a via (step S304). Similar to step 303, if there is a signal wire between a ground line and the dummy pattern or there is no ground wire on the dummy pattern, then the dummy pattern is not connected to a ground wire.

Then, it is determined whether all dummy patterns are connected to a power supply wire or a ground wire (step S305).

In step S305, if it is determined that all of dummy patterns are not connected to a power supply wire or a ground wire (step S305; No), then the state of a layout including the arrangement of the formed dummy pattern and the connection between dummy patterns is shown as a design result (step S306).

Next, it is determined whether the layout can be corrected or not (step S307). Then, a design result of a current layout is output as a stream (step S308). Next, an operator corrects the layout with design CAD by using the stream which is output (step S309) and the operation is returned to step S302.

### SUMMARY

The present inventors have found a problem with the above-described design sequence, as per the following. In the technique of Ito, if there is a dummy pattern which is not connected to a power supply wire or a ground wire, and if it is impossible to correct the layout, then the area where metals are partly sparse and partly dense cannot be removed from the chip.

FIGS. 31 and 32 are views showing examples that the area where metals are partly sparse and partly dense cannot be removed because it is impossible to correct the layout. FIG. 31 shows a plain view of the chip before forming a dummy pattern 501. FIG. 32 shows a plain view of the chip forming a dummy pattern 501. In FIGS. 31, 32, 502 is a power supply wire of a first layer, 503 is a signal wire of a second layer, and 504 is a signal wire of a third layer. The dummy pattern 501 is formed in the area where the signal wire of the third layer is sparse.

The signal layer of the second layer 503 is formed in a direction perpendicular to the power supply line of the first layer 502. The signal wire of the third layer 504 is formed parallel to the power supply wire of the first layer 502. Further, the dummy pattern 501 is formed parallel to the power supply wire of the first layer 502 and is spaced from the signal wire of the third layer 504 by predetermined distance.

In this case, the dummy pattern 501 cannot connect to the power supply wire of the first layer 502 because of the signal wire of the second layer 503. Further, the layout cannot be modified because the wire position of the signal wire of the second layer 503 cannot be changed, as described in Ito. Therefore, it is impossible to form the dummy pattern 501, and the sparseness and denseness of metals cannot be removed.

A first exemplary aspect of an embodiment of the present invention is a layout design device of a semiconductor integrated device including a plurality of laminated layers in which wires are formed. The layout design device comprising a calculation processing portion that calculates a degree of wire congestion of each layer based on a pre-wiring design data to form a desired wiring structure in each layer, a selection processing portion that selects one area from a plurality of areas as a selection area, the semiconductor device being divided into predetermined areas as the plurality of areas, and when a degree of wire congestion of the selection area of an nth layer (n is an integer number and n=2) is lower than that of an (n−1)th layer, which is a layer below the nth layer, or an (n+1)th layer, which is a layer above the nth layer, the selection processing portion selecting a power supply and ground including layer which is a layer below the (n−1)th layer or a layer above the (n+1)th layer and includes a power supply or a ground, and an adding processing portion that generates a post-addition design data by adding a design data which connects the power supply and ground including layer and the (n−1)th layer or the (n+1)th layer to the pre-wiring design data. A wiring process and a metal generating process are performed based on the post-addition design data.

According to the first exemplary embodiment, since after-additional design data (post-addition design data) which is allocated the power supply or ground in the upper layer ((n+1)th layer) of the nth layer or in the under layer ((n−1)th layer) of the nth layer is generated preliminarily before the wiring processing in cases where the metal was formed after the wiring processing of nth layer, it is possible to connect the metal with the power supply or ground. Therefore, it is possible to remove the sparseness and denseness of the metals and to prevent generating the midpoint potential by connecting the metals with the power supply or the ground. Further, the delay fluctuation due to the cross talk can be prevented and it is possible to improve the accuracy of the delay of calculation.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing one example of a layout design device of a semiconductor integrated circuit according to a first exemplary embodiment of the invention;

FIG. 2 is a flow chart showing a layout design method in the layout design device according to the first exemplary embodiment of the invention;

FIG. 3 is a flow chart showing a layout design method in the layout design device according to the first exemplary embodiment of the invention;

FIG. 4 is a plan view showing a condition before wiring;

FIG. 5 is a plan view showing a condition after wiring;

FIG. 6 is a plan view showing (n−1)th layer of the semiconductor integrated circuit;

FIG. 7 is a conceptual diagram showing (n−1)th layer of the case where the power supply is added;

FIG. 8 is a plan view showing nth layer of the semiconductor integrated circuit;

FIG. 9 is a plan view showing (n+1)th layer of the semiconductor integrated circuit;

FIG. 10 is a conceptual diagram showing (n+1)th layer of the case where the power supply is added;

FIG. 11 is a cross-sectional view showing each layer;

FIG. 12 is a view showing an effect of the layout design device of a semiconductor integrated circuit according to a first exemplary embodiment of the invention;

FIG. 13 is a view showing an effect of the layout design device of a semiconductor integrated circuit according to the first exemplary embodiment of the invention;

FIG. 14 is a view showing an effect of the layout design device of a semiconductor integrated circuit according to the first exemplary embodiment of the invention;

FIG. 15 is a view showing an effect of the layout design device of a semiconductor integrated circuit according to the first exemplary embodiment of the invention;

FIG. 16 is one example showing a layout design device of a semiconductor integrated circuit of a second exemplary embodiment of the present invention;

FIG. 17 is a flow chart showing a layout design method in the layout design device according to the second exemplary embodiment of the invention;

FIG. 18 is a flow chart showing a layout design method in the layout design device according to the second exemplary embodiment of the invention;

FIG. 19 is a flow chart showing a layout design method in the layout design device according to the second exemplary embodiment of the invention;

FIG. 20 is a view showing the search scope;

FIG. 21 is a plan view showing a first layer where a power supply is not added;

FIG. 22 is a plan view showing a first layer where a power supply is added;

FIG. 23 is a cross sectional view showing a first layer, a second layer, a third layer and a fourth layer;

FIG. 24 is an example of a layout design device according to the third exemplary embodiment of the present invention;

FIG. 25 is a flow chart showing layout design method in the layout design device according to the third exemplary embodiment of the invention;

FIG. 26 is a flow chart showing layout design method in the layout design device according to the third exemplary embodiment of the invention;

FIG. 27 is a flow chart showing layout design method in the layout design device according to the third exemplary embodiment of the invention;

FIG. 28 is a view to explain a method for calculating the degree of wire congestion according to the third exemplary embodiment of the invention;

FIG. 29 is a view to explain a method for calculating the degree of wire congestion according to the third exemplary embodiment of the invention;

FIG. 30 is a flow chart showing a method for forming a metal in Ito;

FIG. 31 is a view to explain a method for generating a metal according to the related art; and

FIG. 32 is a view to explain a method for generating a metal according to the related art.

### DETAILED DESCRIPTION OF THE EXEMPLARY EMBODIMENTS

### First Exemplary Embodiment

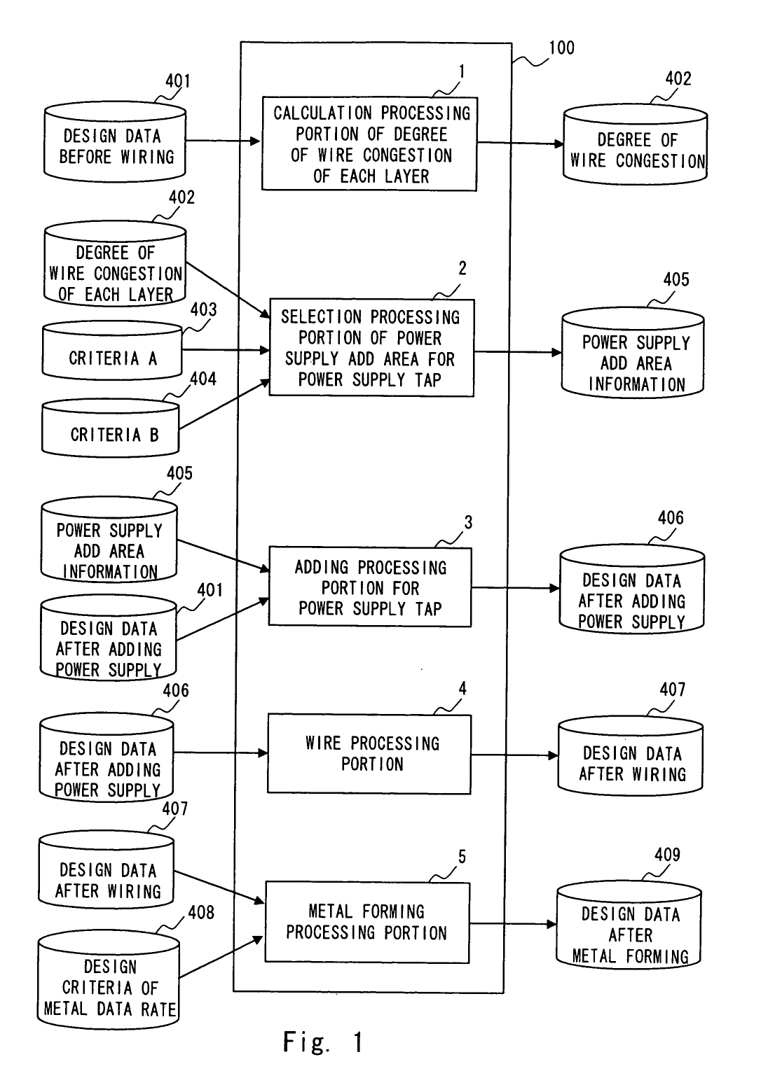

FIG. 1 shows one example of a layout design device of a semiconductor integrated circuit according to a first exemplary embodiment of the invention. As shown in FIG. 1, the layout design device 100 includes a calculation processing portion of a degree of wire congestion of each layer 1 (hereinafter referred to as “the calculation processing portion” with simplification), a selection processing portion of a power supply add area for power supply tap 2 (hereinafter referred to as “the selection procession portion” with simplification), a power supply adding processing portion for power supply tap 3 (hereinafter referred to as “the adding processing portion” with simplification), a wire processing portion 4 and metal forming processing portion 5.

The pre-wiring design data 401 is input into the calculation processing portion 1. Then the calculation processing portion 1 calculates the degree of wire congestion 402 of each layer based on the pre-wiring design data 401, and outputs it.

A degree of wire congestion 402 of each layer which has been calculated by the calculation processing portion 1 is input into the selection processing portion 2. Further, a criterion A403 (a first criterion) and a criterion B404 (a second criterion) are input into the selection processing portion 2. The criterion B404 is larger than the criterion A403. Then the selection processing portion 2 selects a power supply add area and outputs power supply add area information 405 based on the degree of wire congestion 402 of each layer, the criterion A403 and the criterion B404. Note that, as the criterion A403 and the criterion B404 depend on a design criterion or design data, a designer may decide them arbitrarily.

The power supply add area information 405 from the selection processing portion 2 is input into the adding processing portion 3. Furthermore, pre-wiring design data 401 is input into the adding processing portion 3. Then the adding processing portion 3 generates and outputs post-power supply addition design data 406 to which a power supply is added.

The post-power supply addition design data 406 which the adding processing portion 3 has generated is input into the wire processing portion 4. The wire processing portion 4 generates and outputs post-wiring design data 407 based on the post-power supply addition design data 406 to which a power supply is added.

The post-wiring design data 407 which the wire processing portion 4 has generated is input into the metal forming processing portion 5. Further, design criterion 408 of a metal data rate is input into the metal forming processing portion 5. Then the metal forming processing portion 5 generates and outputs design post-metal forming data 409 based on the post-wiring design data 407 and the design criterion 408 of the metal data rate.

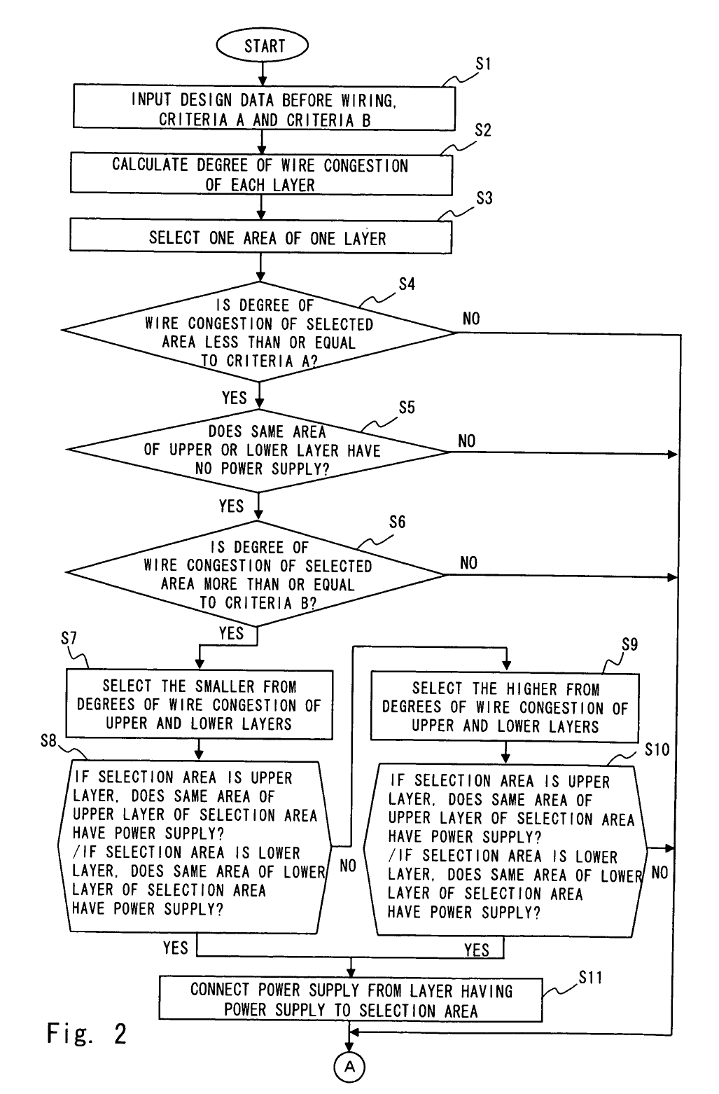

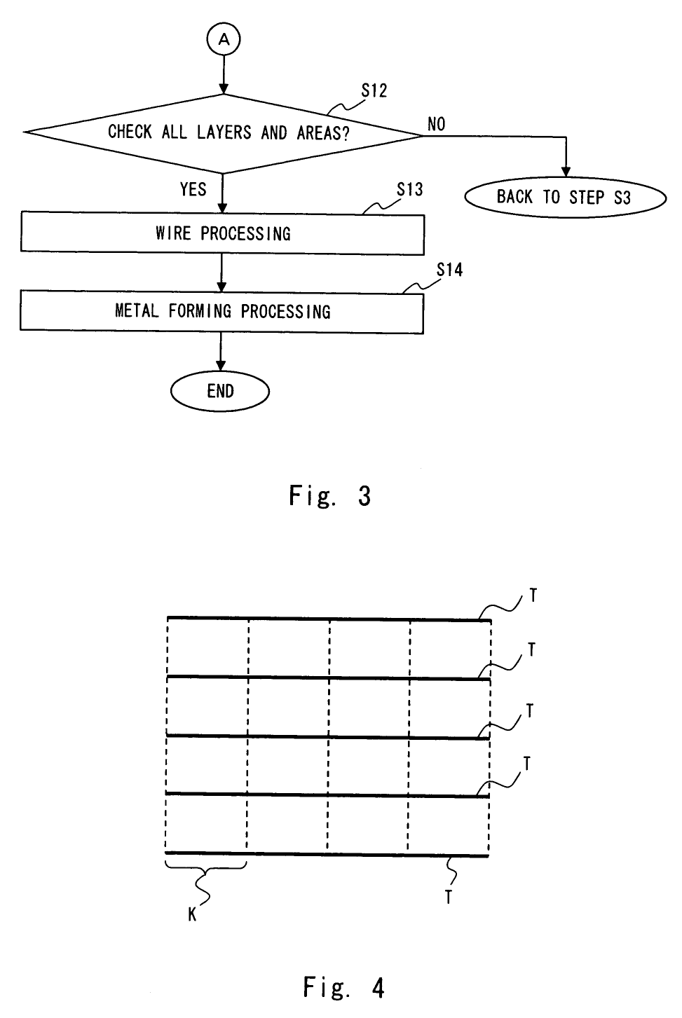

Next, layout design method in the layout design device 100 of the first exemplary embodiment of the present invention will be described with reference to flow charts of FIGS. 2 and 3.

Firstly, the pre-wiring design data 401, the criterion A403 and the criterion B404 are input into the layout design device 100 (step S1).

Next, the calculation processing portion 1 calculates the degree of wire congestion 402 of each layer (step S2). The degree of wire congestion 402 is the proportion of the area occupied by a wire track T in which wire is used in predetermined area. The predetermined area is an arbitrary area and is decided by a designer.

Specifically, firstly, the calculation processing portion 1 calculates a wire amount. Then the calculation processing portion 1 calculates the degree of wire congestion 402 based on the wire amount. The calculation processing portion 1 calculates the wire amount based on place information included in the pre-wiring design data 401. Alternatively the calculation processing portion 1 calculates a wire amount from a rough wiring result based on the pre-wiring design data 401. Alternatively the calculation processing portion 1 calculates the wire amount from a result which has been obtained by actually performing the wiring based on the pre-wiring design data 401.

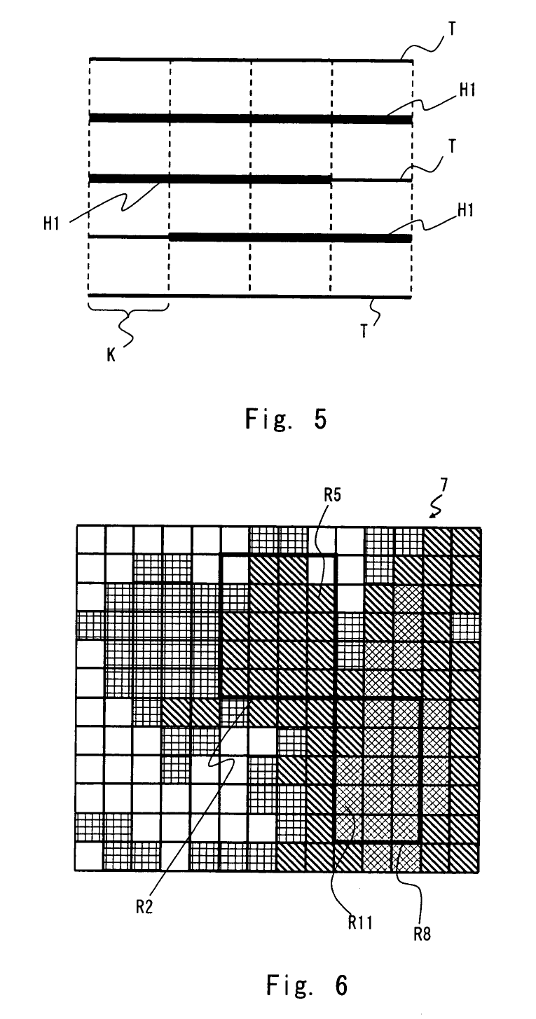

A method for calculating of the degree of wire congestion 402 by calculating the wire amount from a result obtained by actually performing the wiring based on the pre-wiring design data 401 will be described with reference to FIGS. 4 and 5.

FIG. 4 is a plan view showing a state before wiring, and FIG. 5 is a plan view showing a state after wiring. As shown in FIGS. 4 and 5, a predetermined area of a layer for which the degree of wire congestion 402 is calculated is a rectangular area. The area is demarcated by sixteen grids K which have four grids in the horizontal direction and have four grids in the vertical direction. Five wire tracks are formed along a horizontal line of each grid K from the top side to the bottom side of this area. The wire track T is configured such that a wire H1 can be laid down on it. As shown in FIG. 4, the total amount of wire tracks T in which a wire H1 can be laid down is twenty grids which is four grids×five lines. As shown in FIG. 5, in this case, a wire H1 whose size is same as four grids is laid down in a wire track which is the second line from the top, a wire H1 whose size is same as three grids is laid down in a wire track which is the third line from the top, and a wire H1 whose size is same as three grids is laid down in a wire track which is the fourth line from the top. In this case, the amount of the wire H1 is expressed by the total length that the wire H1 is laid down, and therefore the total length is ten grids, that is four grids+three grids+three grids. The degree of wire congestion 402 is expressed by the following expression, that is the percentage of the wiring H1 of the wiring track T in which wiring is possible. The degree of wire congestion 402 is 50%.

the degree of wire congestion (the total length of wire)/(the total wire track)×100=(4+3+3)/(4×5)×100=10/20×100=50

Next, the selection processing portion 2 selects one area of one layer, and sets the area as a selection area (step S3). For example, the selection processing portion 2 selects a part of area of a layer 6 which is the nth (wherein n is integer number meeting n=2) layer from the underside direction of the lamination. Then, the selection processing portion 2 determines whether the degree of wire congestion 402 of the selection area is less or equal to the criterion A403 (step S4).

In step S4, in the cases where the selection processing portion 2 determines that the degree of wire congestion 402 of the selection area is more than the criterion A403 (step S4; No), the process goes to step S12.

In step S4, in the cases where the selection processing portion 2 determined that the degree of wire congestion 402 of the section area is less or equal to the criterion A403 (step S4; Yes), the selection processing portion 2 determines whether there is a power supply in the same area of upper and lower layer ((n+1)th layer 8, (n−1)th layer 7) (step S5).

In step S5, if the selection processing portion 2 determines there is a power supply in the same area of the upper and lower layer of the selection area (step S5: No), then the process goes to step S12.

In step S5, if the selection processing portion 2 determines there is no power supply in the same area of the upper and lower layer of the selection area (step S5: Yes), then the selection processing portion 2 determines whether the degree of wire congestion 402 of the same area of the upper and lower layer of the selection area is equal to or more than the criterion B404 (step S6).

In step S6, if the selection processing portion 2 determines the degree of wire congestion 402 of the same area of the upper and lower layer of the selection area is smaller than the criterion B404 (step S6; No), then the process goes to step S12.

In step S6, if the selection processing portion 2 determines the degree of wire congestion 402 of the same area of the upper and lower layer of the selection area is equal to or more than the criterion B404 (step S6; Yes), then the selection processing portion 2 selects the smaller one from the degrees of wire congestion 402 of the upper and lower layers (step S7).

Next, if the selected area of step S7 is an upper layer of the selection area (which is the selected area of step S3), the selection processing portion 2 determines whether there is a power supply in the same area of further upper layer of the area which is selected in step S7. If the selected area of step S7 is a lower layer of the selection area (which is the selected area of step S3), the selection processing portion 2 determines whether there is a power supply in the same area of further lower layer of the area which is selected in step S7 (step S8).

In step 8, if the selection processing portion 2 determines there is no power supply in the upper or lower layer than the area which is selected in step S7 (step S8; No), the selection processing portion 2 selects the higher degree of wire congestion 402 of the selection area (which is selected in step S3) of the upper and lower layer (step S9).

Then if the area selected in step S9 is an upper layer than the selection area (which is selected in step S3), the selection processing portion 2 determines whether there is a power supply in the same area of further upper area than the area selected in step S9. Or if the area selected in step S9 is a lower layer than the selection area (which is selected in step S3), the selection processing portion 2 determines whether there is a power supply in the same area of a further lower area than the area selected in step S9 (step S10).

In step S10, the selection processing portion 2 determines there is no power supply in the upper or lower than the area selected in step S9 (step S10; No), and the process goes to step S12.

On the other hand, if the selection processing portion 2 determines there is a power supply in the upper or lower layer than the area selected in step S7 in step S8, (step S8; Yes), and if the selection processing portion 2 determines there is a power supply in the upper or lower layer than the area selected in step S9 in step S10, (step S10; Yes), then the selection processing portion 2 outputs information including the area information including the power supply as the power supply add area information 405. Then the adding processing portion 3 connects a power supply from the area indicated by the power supply add area information 405 to the selection area and outputs the post-power supply addition design data 406 (step S11).

Then, the layout design device 100 determines whether all layers and areas have been checked or not (step S12).

In step S12, if the layout design device 100 determines that all layers and areas have been not checked (step S12 No), then the process goes to step S3.

In step S12, if the layout design device 100 determines that all layers and area have been checked (step S12; Yes), the wire processing portion 4 executes wire processing based on the post-power supply addition design data 406 to which a power supply is added and outputs the post-wiring design data 407 (step S13).

Next, the metal forming processing portion 5 executes metal generation processing based on the post-wiring design data 407 and the design criterion 408.

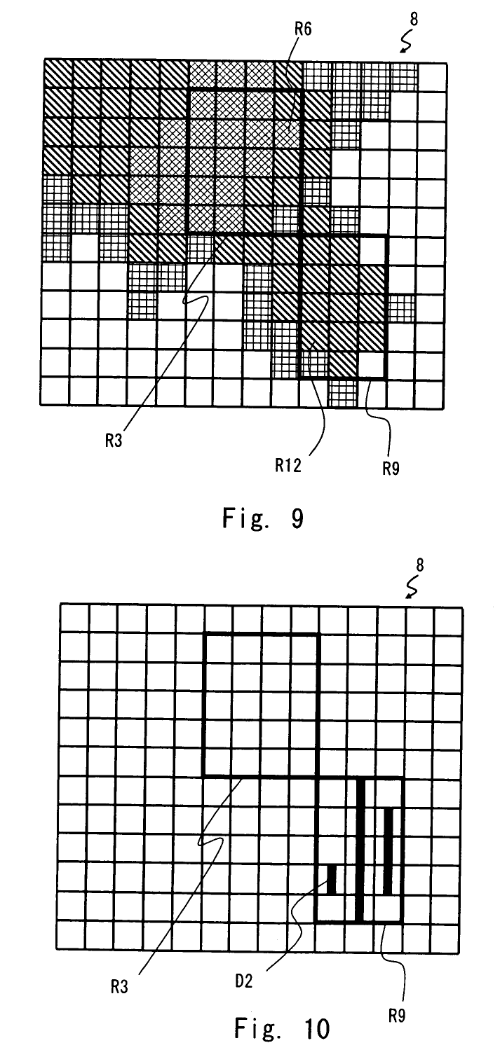

Next, layout design operation according to the layout design device 100 of the first exemplary embodiment of the present invention will be explained with reference to FIGS. 6-11.

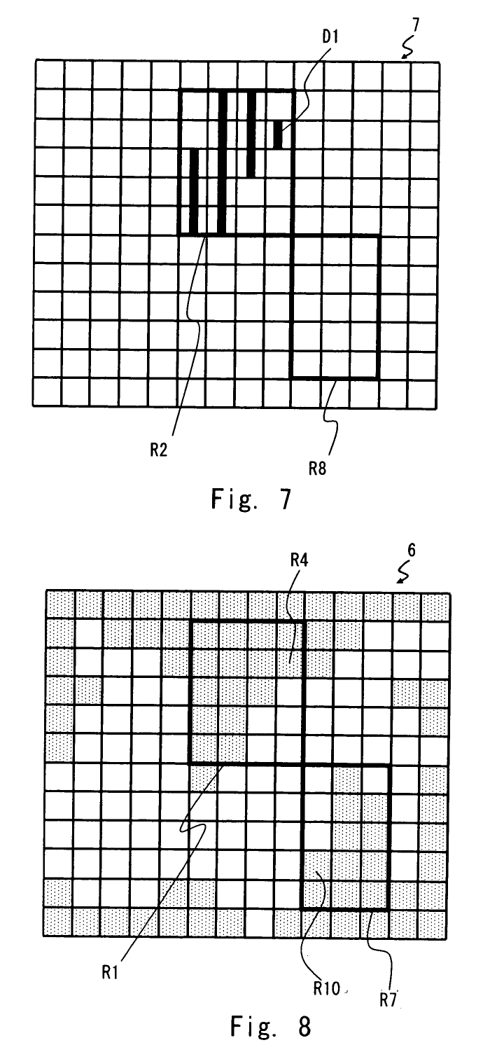

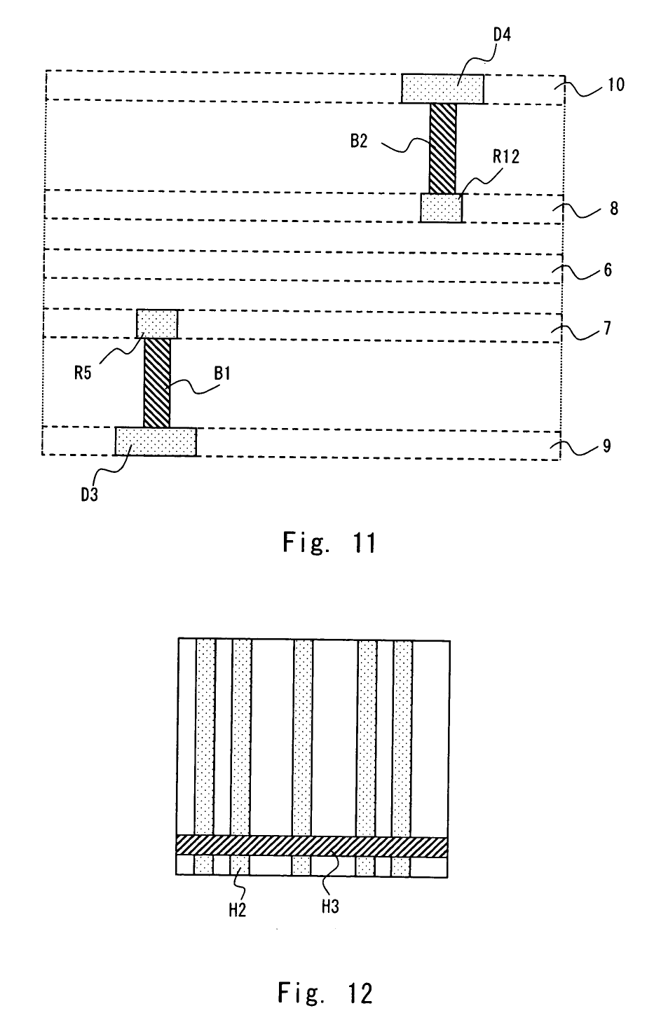

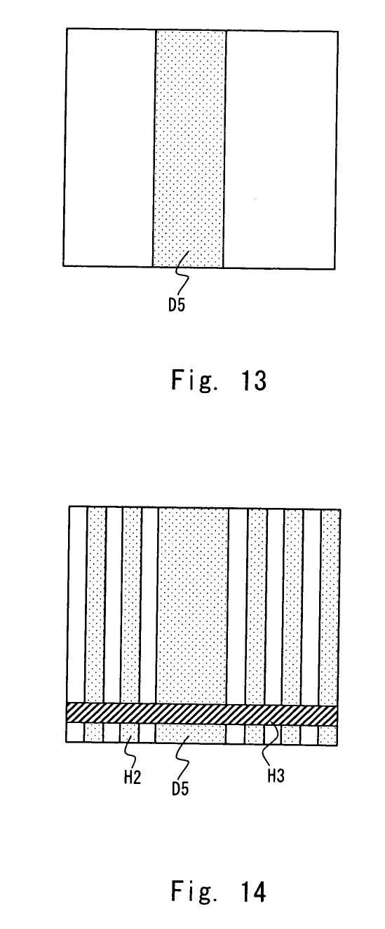

FIGS. 6, 8 and 9 are plan views showing (n−1)th layer 7, nth layer 6 and (n+1)th layer 8 of the semiconductor integrated circuit (where n is integer number, n=2). Further, FIG. 7 is a conceptual diagram showing (n−1)th layer of the case where the power supply D1 is added, and FIG. 10 is a conceptual diagram showing (n+1)th layer of the case where the power supply D2 is added. Furthermore, FIG. 11 is a cross-sectional view showing each layer.

In FIGS. 6, 8 and 9, the degree of wire congestion 402 of the areas which are shown by dots is equal to or less than 20%, and the degree of wire congestion 402 of the areas which are shown by solid color is more than 20% and less than 60%, the degree of wire congestion 402 of the areas which are shown by the “waffle pattern” is equal to or more than 60% and less than 70%, the degree of wire congestion 402 of the areas which are shown by diagonal lines is equal to or more than 70% and less than 80%, the degree of wire congestion 402 of the areas which are shown by the “dragon skins” pattern is equal to or more than 80%.

In addition, the degree of wire congestion of the criterion A403 is 20% and the degree of wire congestion of the criterion B404 is 70%.

As shown in FIG. 8, the degree of wire congestion 402 of the area R1 of the nth layer 6 is equal to or less than the criterion A403. Further, the same area R2 as the area R1 of (n−1)th layer 7 and the same area R3 as the area R1 of the (n+1)th layer 8 do not have a power supply.

Furthermore, for example, the degree of wire congestion 402 of the area R1 of the nth layer 6 is equal to or less than 20%, the degree of wire congestion 402 of the same area R5 as the area R4 of the (n−1)th layer 7 is equal to or more than 70% and less than 80% and the degree of wire congestion 402 of the same area R6 as the area R4 of (n+1)th layer 8 is equal to or more than 80%. Therefore, the degree of wire congestion 402 of the area R5 of the (n−1)th layer 7 is lower than that of the area R6 of the (n+1)th layer 8. In the layer which is lower than (n−1)th layer 7, in the case where there is a layer 9 (the layer including a power supply and a ground) which has a power supply D3 in the same area as the area R5, a power supply is added to the area R5 of the (n−1)th layer 7 by connecting the layer 9 including the power supply D3 and the area R5. FIG. 7 is a conceptual diagram showing the power supply D1 which is added. As shown in FIG. 11, the layer 9 which is the lower layer than the (n−1)th layer 7 and includes the power supply D3 and the (n−1)th layer 7 are connected by a via B1. This connects the power supply D3 which is in the lower layer than the (n−1)th layer 7 and the area R5 of the (n−1)th layer 7.

On the other hand, the degree of wire congestion 402 of the area R7 of the nth layer 6 is equal to or less than the criterion A403. Further, the same area R8 as the area R7 of the (n−1)th layer 7 and the same area R9 as the area R7 of the (n+1)th layer 8 do not have a power supply.

Furthermore, for example, the degree of wire congestion 402 of the area R10 of the nth layer 6 is equal to or less than 20%, the degree of wire congestion 402 of the same area R11 as the area R10 of the (n−1)th layer 7 is equal to or more than 80%, and the degree of wire congestion 402 of the same area R12 as the area R10 of the (n+1)th layer 8 is equal to or more than 70% and less than 80%. Therefore, the degree of wire congestion 402 of the R12 of the (n+1)th layer 8 is lower than that of the area R11 of the (n−1)th layer 7. In the case where there is a layer 10 (the layer including a power supply and a ground) in the same area as the area R12 of a layer which is an upper layer than the (n+1)th layer 8, the power supply is added in the area R12 of the (n+1)th layer 8 by connecting the layer 10 including the power supply D4 and the area R12 of the (n+1)th layer 8. FIG. 10 is a conceptual diagram showing the power supply D2 which is added. Furthermore, as shown in FIG. 11, the layer 10 which is an upper layer than the (n+1)th layer 8 and has the power supply D4 is connected to the (n+1)th layer 8 by a via B2. This connects the power supply D4 which is an upper layer than the (n+1)th layer 8 and the area R12 of the (n+1)th layer 8.

As described above, the layout design device 100 includes the calculation processing portion 1 which calculates the degree of wire congestion of each layer based on the pre-wiring design data 401 which is a data for forming desired wiring structure in each layer, the selection processing portion 2 which selects the layer 9 and 10 which have a power supply and are lower layers than the (n−1)th layer 7 or upper layers than the (n+1)th layer 8 in the case where the degree of wire congestion 402 of a selecting area, which is selected among a plurality of areas, of the nth layer 6 which is the nth (n is integer number, n=2) layer from the lowest layer in a lamination direction is lower than that of the (n−1)th layer 7 which is the lower layer than nth layer 6 and that of the (n+1)th layer 8 which is the upper layer than the nth layer 6, and the adding processing portion 3 which generates the after adding design data by adding the design data, which connects the layers 9 and 10 including the power supply and the (n−1)th layer 7 or the (n+1)th layer 8, to the before wiring design data, and wires the semiconductor integrated circuit and generates the metal based on the after adding design data.

According to the layout design device 100 and the layout design method of semiconductor integrated circuit of the first exemplary embodiment of the present invention, before the wiring processing, preliminarily, since the after adding design data in which a power supply is allocated in the lower layer than the nth layer (the (n−1)th layer 7) or the upper layer than the nth layer 6 (the (n+1)th layer 8) is generated, if the metal is generated after wire processing of the nth layer 6, the metal can be connected to a power supply metal. This can eliminate the sparseness and denseness of the metals, and can prevent generating the midpoint potential by connecting the metal which has been generated to the power supply. Further, the layout design device 100 can prevent the delay fluctuation by cross talk and can improve the accuracy of the delay of calculation.

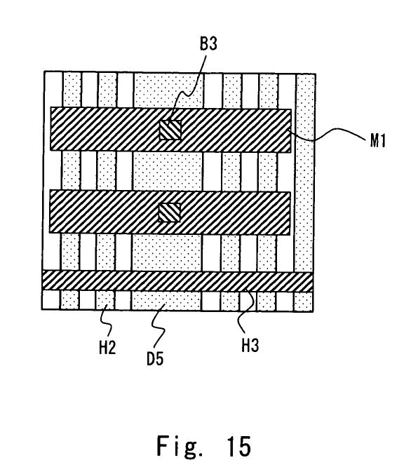

For example, as shown in FIG. 12, in a lower layer of a given area, a plurality of low signal wirings H2 are arranged parallel to each other, so the metal is dense. On the other hand, in an upper layer of the given area, an upper signal wiring H3 is arranged in a direction perpendicular to the lower signal wirings H2, so the metal is sparse. If there is a power supply in the same area of a lower layer than the layer which has the lower signal wirings H2, as shown in FIG. 13, the power supply D5 is added to the layer which has the lower signal wirings H2. FIG. 14 shows the state showing the power supply D5 being added. As shown in FIG. 15, a metal M1 is added to the layer which has the upper signal wiring H3 to eliminate the sparseness and denseness of the metals. Further, the metal M1 generated in the upper layer is connected to the power supply D5 added to the lower layer by the via B3. That is, the metal M1 which has been generated can be connected to a power supply. This can eliminate the sparseness and denseness of the metal of each layer and can prevent generating the midpoint potential by connecting the metal which has been generated to a power supply. Further, the layout design device 100 can prevent the delay fluctuation by cross talk and can improve the accuracy of the delay of calculation.

### Second Exemplary Embodiment

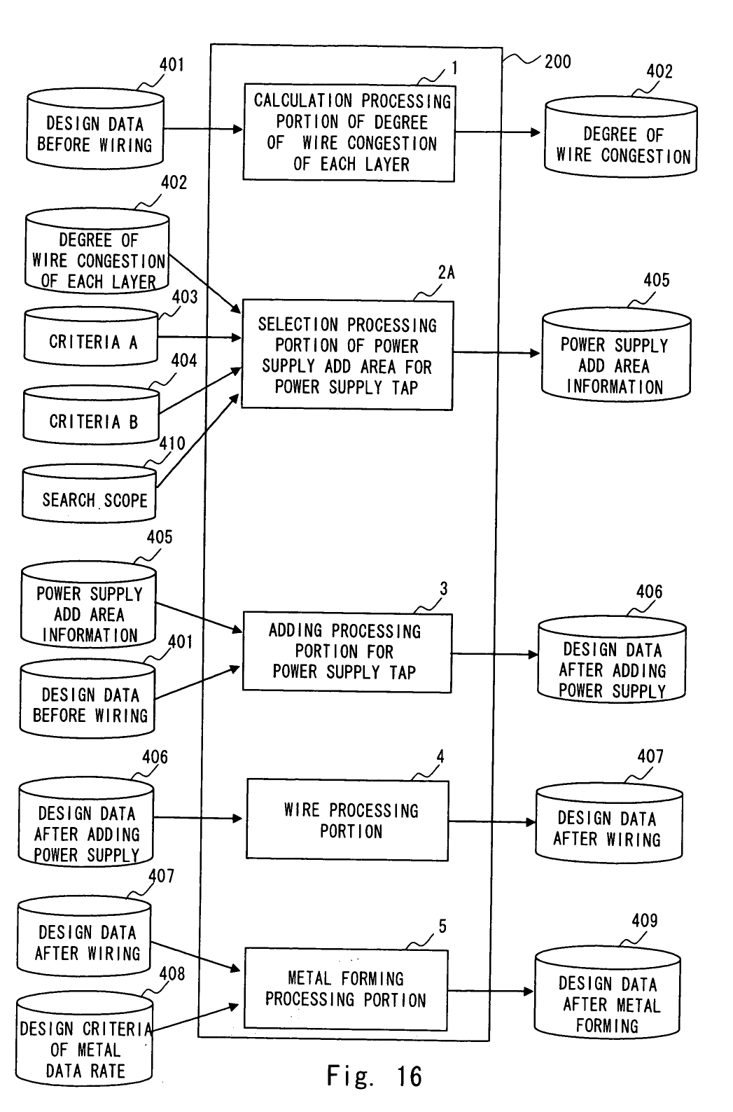

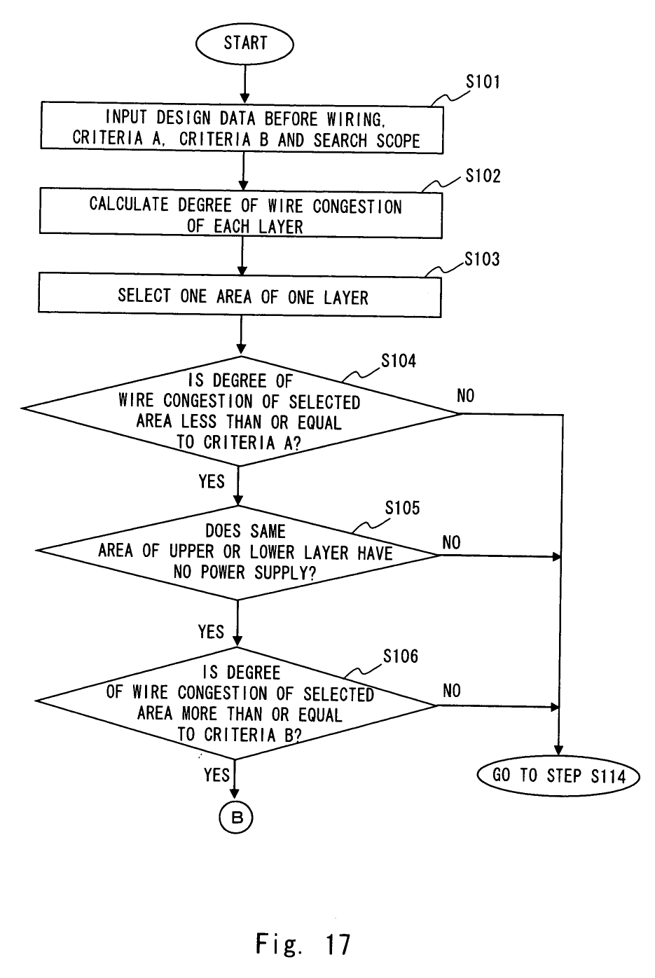

FIG. 16 is an example showing a layout design device 200 of a semiconductor integrated circuit of the second exemplary embodiment of the present invention. As shown in FIG. 16, the layout design device 200 includes a selection processing portion of a power supply add area for power supply tap 2A (hereinafter referred to as “the selection procession portion 2A” with simplification), and only selection procession portion 2A is different from that of the layout design device 100. Therefore, the same elements as in the first exemplary embodiment are denoted by the same reference symbols and not described in detail herein.

The degree of wire congestion 402 of each layer which has been calculated by the calculation processing portion 1 is input into the selection procession portion 2A. Further, the criterion A403 and the criterion B404 are input into the selection procession portion 2A. Then the selection procession portion 2A selects the power supply add area based on the degree of wire congestion 402 of each layer, the criterion A403, the criterion B404 and the search scope 410, and outputs the power supply add area information 405.

The search scope 410 is a scope where the selection procession portion 2A searches when the selection procession portion 2A searches for layers which include a power supply and are upper layers or lower layers than an area (selection area) where a power supply is added. For example, the larger the number of the search scope 410 becomes, the larger the scope of the area where the layout design device 200 searches becomes. The number of the search scope 410 is arbitrary and is set by a designer. Therefore, the number of the search scope 410 can be changed depending on a power supply structure of the design data.

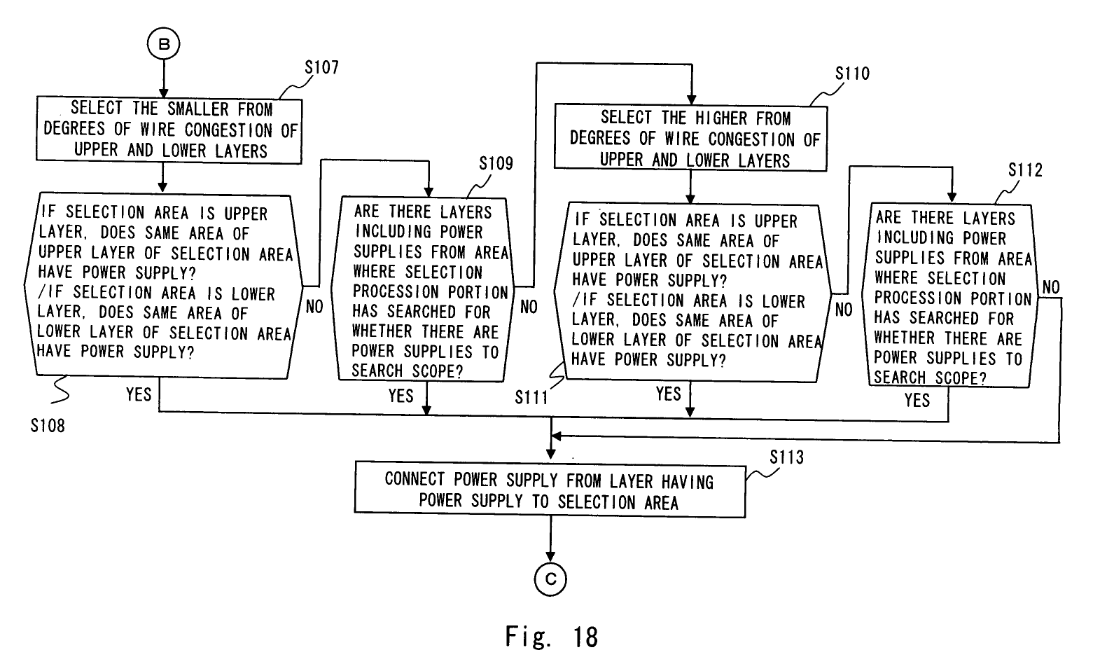

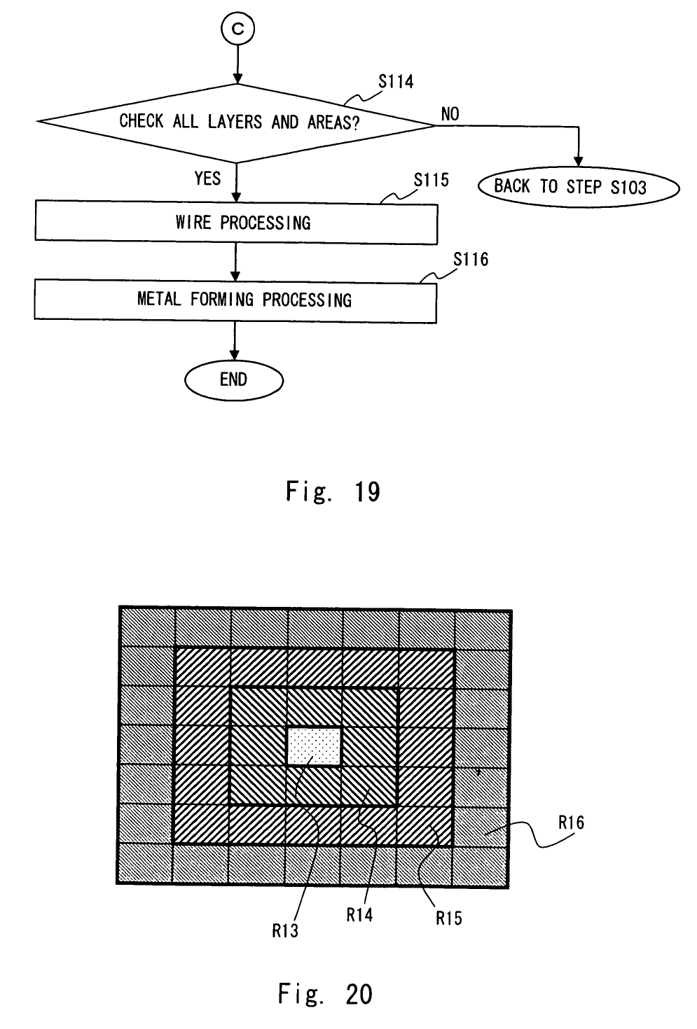

Next, layout design method according to the layout design device 200 of the second exemplary embodiment of the present invention will be explained with reference to flow charts of FIGS. 17-19. Note that, since steps S102-S108 and steps S114-S116 are same as steps S2-S8 and steps S12-S14 shown in FIGS. 2 and 3, the description is omitted.

Firstly, the pre-wiring design data 401, the criterion A403, the criterion B404 and the search scope 410 are input into the layout design device 200 (step S101).

In step S108, if the selection procession portion 2A determines there are no power supplies in upper layers or lower layers than the area where the selection procession portion 2A has selected in step S107 (step S108: No), the selection procession portion 2A determines whether there are layers including power supplies from the area where the selection procession portion 2A has searched for whether there are power supplies in step S108 to the search scope 410 (step S109).

In step S109, if the selection procession portion 2A determines there are no layers including power supplies from the area where the selection procession portion 2A has searched for whether there are power supplies in step S108 to the search scope 410 (step S109: No), the selection procession portion 2A selects the higher one of the degree of the two wire congestions 402 of the upper and lower layers of the selection area (which is selected in step S103) (step S110).

Then, if the area which is selected in step S110 is an upper layer of the area (which is selected in step S103), the selection procession portion 2A determines whether there are power supplies in the same area of a further upper layer than the area which is selected in step S110. Alternatively if the area which is selected in step S110 is a lower layer of the area (which is selected in step S103), the selection procession portion 2A determines whether there are power supplies in the same area of a further lower layer than the area which is selected in step S110 (step S111).

In step S111, if the selection procession portion 2A determines there are no power supplies in upper layers or lower layers than the area which is selected in step S110 (step S111: No), the selection procession portion 2A determines whether there are layers including power supplies from the area where the selection procession portion 2A has searched for whether there are power supplies in step S111 to the search scope 410 (step S112).

In step S112, if the selection procession portion 2A determines there are no layers including power supplies from the area where the selection procession portion 2A has searched for whether there are power supplies in step S111 to the search scope 410 (step S112: No), the process goes to step S114.

On the other hand, if the selection procession portion 2A determines that there are power supplies in upper layers or lower layers than the area where the selection procession portion 2A has selected in step S107 in step S108 (step S108: Yes), if the selection procession portion 2A determines there are layers including power supplies from the area where the selection procession portion 2A has searched for whether there are power supplies in step S108 to the search scope 410 in step S109 (step S109: Yes), if the selection procession portion 2A determines there are power supplies in upper layers or lower layers than the area which is selected in step S111 (step S111: Yes), and if the selection procession portion 2A determines there are layers including a power supply from the area where the selection procession portion 2A has searched for whether there are power supplies in step S111 to the search scope 410 in step S112 (step S112: Yes), the selection procession portion 2A outputs information regarding the area including power supplies as the power supply add area information 405. Then the adding processing portion 3 connects a power supply from the area indicated by the power supply add area information 405 to the selection area and outputs the post-power supply addition design data 406 to which a power supply is added (step S113).

Here, a method for searching for power supplies in steps S109 and S112 will be described with reference to FIG. 20. As shown in FIG. 20, with a central focus on the same area R13 as the area where a power supply is added (selection area), the area R14 is adjacent to the periphery of the area R13, the area R15 is adjacent to the periphery of the area R14, and the area R16 is adjacent to the periphery of the area R15. If the search scope 410 is “1”, an area to the area R14 which is adjacent to the area R13 which is the same area where a power supply is added is the scope where the selection procession portion 2A searches power supplies. If the search scope 410 is “2”, the areas R14 and R15 are the scope where the selection procession portion 2A searches power supplies. If the search scope 410 is “3”, the areas R14, R15 and R16 are the scope where the selection procession portion 2A searches power supplies. The scope where the selection procession portion 2A searches power supplies can be set large by increasing the number of the search scope 410.

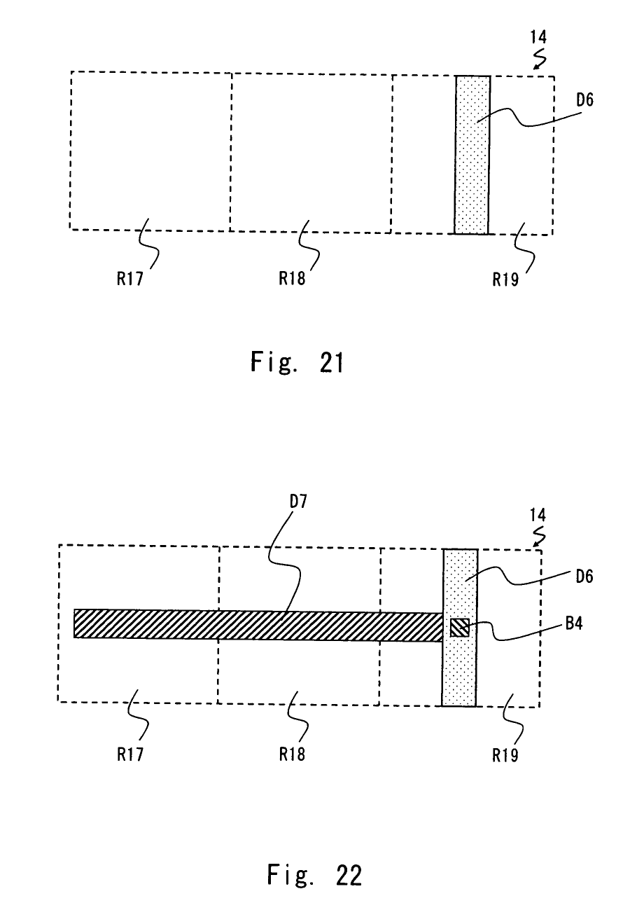

Next, layout design operation according to the layout design device 200 of the second exemplary embodiment of the present invention will be explained with reference to FIGS. 21-23.

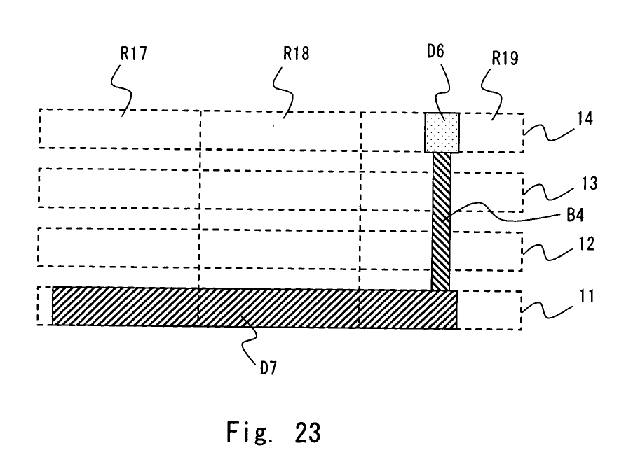

FIG. 21 shows a plan view of a first layer 11 where a power supply D7 is not added in dotted line, and shows a power supply D6 of a fourth layer 14 in solid line. FIG. 22 shows a plan view of a first layer 11 where a power supply D7 is added in dotted line, and shows a power supply D7, a power supply D6 and a via B4 in solid lines. FIG. 23 shows cross sectional views of a first layer 11, a second layer 12, a third layer 13 and a fourth layer 14. As shown in FIG. 23, the layers are stacked in an order of the first layer 11, the second layer 12, the third layer 13 and the fourth layer 14, from the bottom. Each layer is divided into three areas which are an area R17, an area R18 and an area R19. The areas are arranged in an order of the area R17, the area R18 and the area R19, from the left.

There is no power supply in the areas R17 to R19 of the first layer 11, the second layer 12 and the third layer 13, and the areas R17 and R18 of the fourth layer 14, and there is a power supply D6 in the area R19 of the fourth layer 14. Assume that the search scope 410 is set to “2”.

In this case, the selection procession portion 2A search for power supplies in the areas R17 to R19 of the second layer 12, the third layer 13 and the fourth layer 14. Then the selection procession portion 2A determines there is the power supply D6 in the area R19 of the fourth layer 14, and outputs the power supply add area information 405. The adding processing portion 3 connects the area R17 of the first layer 11 and the power supply D6 based on the power supply add area information 405.

Specifically, as shown in FIGS. 22 and 23, a via B4 is formed from the area R19 of the first layer 11 to the area R19 of the fourth layer 14. This connects a power supply D6 of the fourth layer 14 and the area R17 of the first layer 11 through a via B4, and a power supply D7 is added from the area R19 to R17 of the first layer 11.

As described above, in the layout design device 200 and layout design method according to the second exemplary embodiment of the present invention, the selection procession portion 2A selects a layer including a power supply by searching the search scope 410 which has a predetermined size with a central focus on the selection area. Then the adding processing portion 3 connects the first layer 11 and the fourth layer 14 including the power supply D6 by the via B4. This connects the area R19 of the first layer 11 and the power supply D6 and the power supply D7 is added from the area R19 to the area R17 (selection area) of the first layer 11.

Therefore, if there is no power supply in the area R17 (selection area) of an upper layer than the first layer 11 (the second layer 12) in the case where there is the power supply D6 within the search scope 410 with a central focus on the selection area, the power supply D6 can be connected to the first layer 11 through the via B4. This can decrease the number of cases where power supplies cannot be added.

### Third Exemplary Embodiment

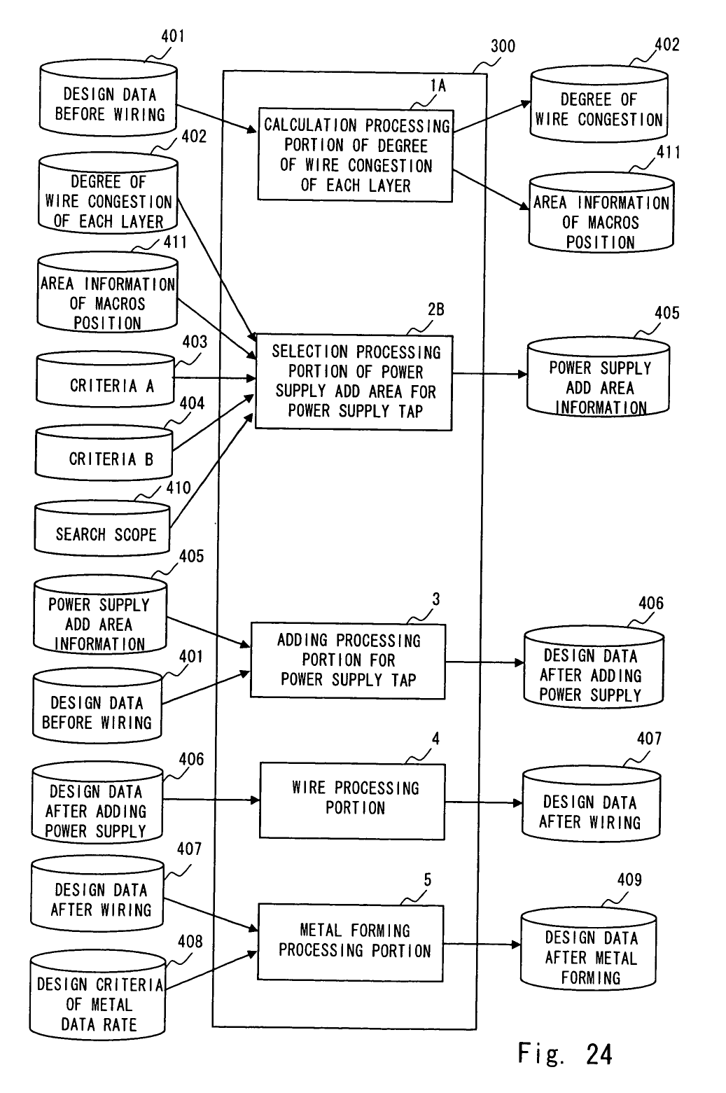

FIG. 24 is an example of a layout design device 300 according to the third exemplary embodiment of the present invention. As shown in FIG. 24, the layout design device 300 includes a calculation processing portion of a degree of wire congestion of each layer 1A (hereinafter referred to as “the calculation processing portion 1A” with simplification), a selection processing portion of a power supply add area for power supply tap 2B (hereinafter referred to as “the selection procession portion 2B” with simplification), and only these elements are different from those of the layout design device 200. Therefore, the same elements as in the second exemplary embodiment are denoted by the same reference symbols and not described in detail herein.

The pre-wiring design data 401 is input into the calculation processing portion 1A. Then the calculation processing portion 1A calculates the degree of wire congestion 402 of each layer based on the pre-wiring design data 401. Further, the calculation processing portion 1A outputs the degree of wire congestion 402 and area information 411 on macro positions.

The degree of wire congestion 402 of each layer and the area information 411 on the macro positions are input into the selection procession portion 2B from the calculation processing portion 1A. Further, the criterion A403, the criterion B404 and the search scope 410 are input into the selection procession portion 2B. Then the selection procession portion 2B selects a power supply add area based on the degree of wire congestion 402 of each layer, the area information 411 of the macro positions, the criterion A403, the criterion B404 and the search scope 410, and outputs the power supply add area information 405.

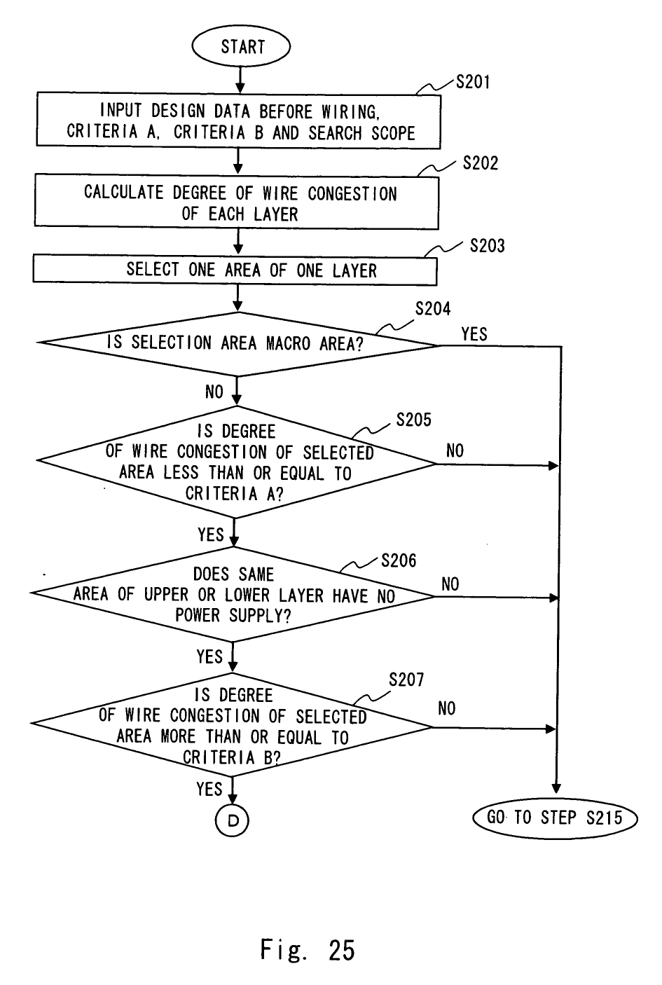

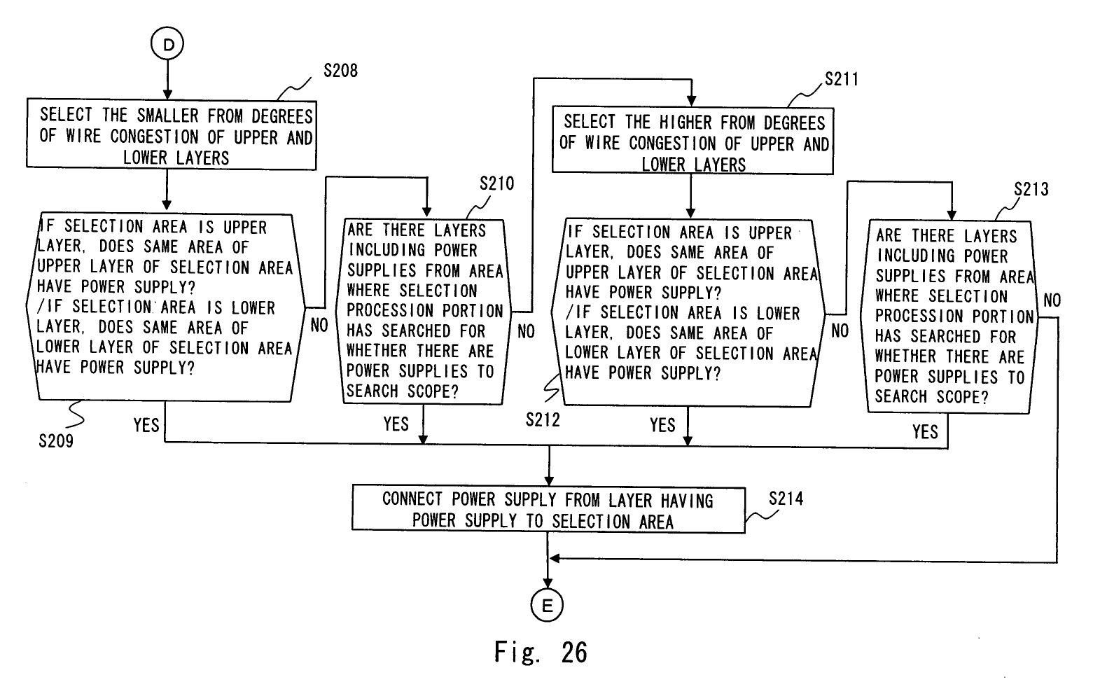

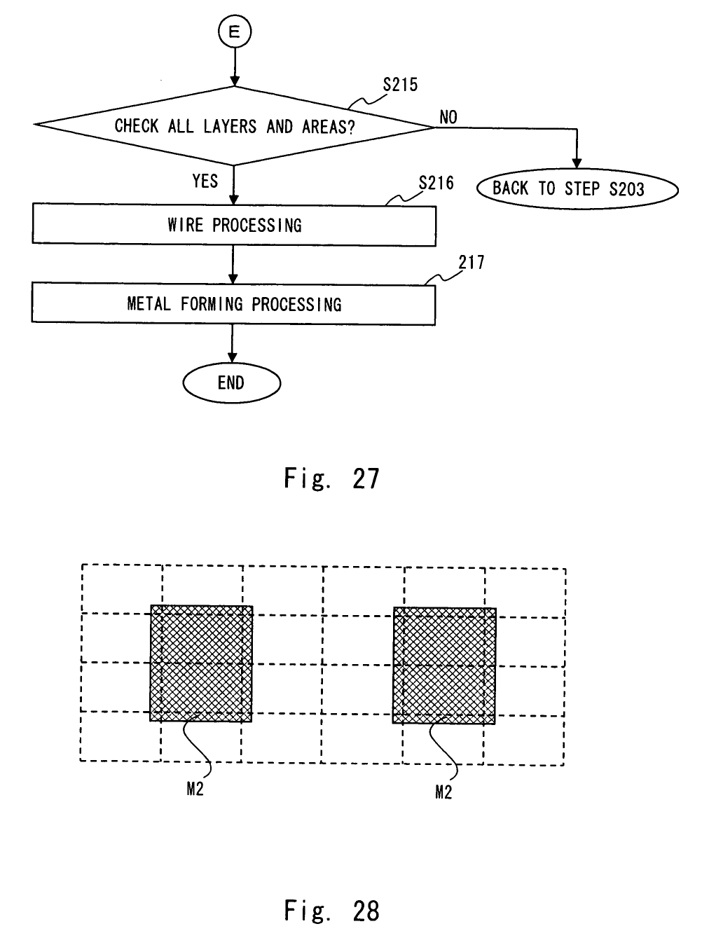

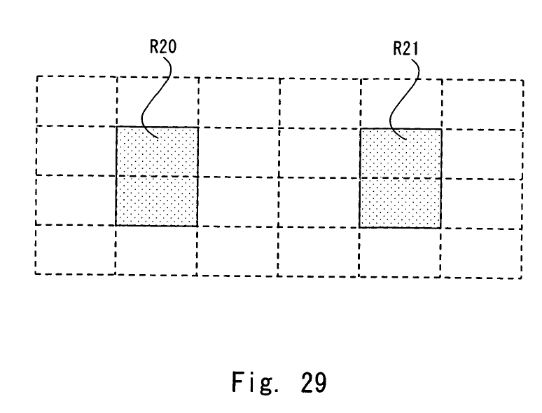

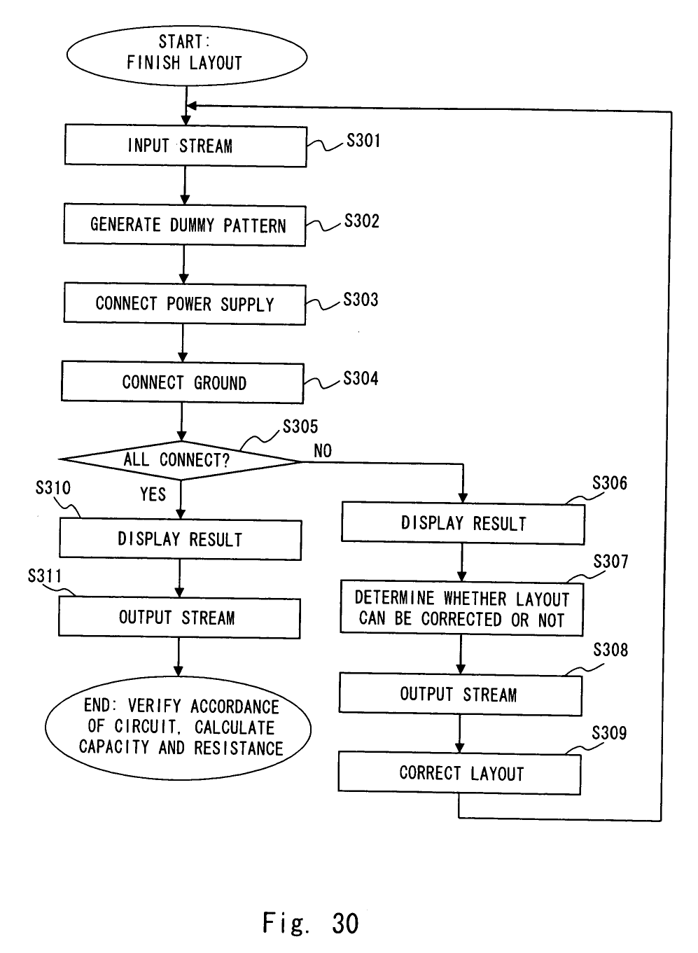

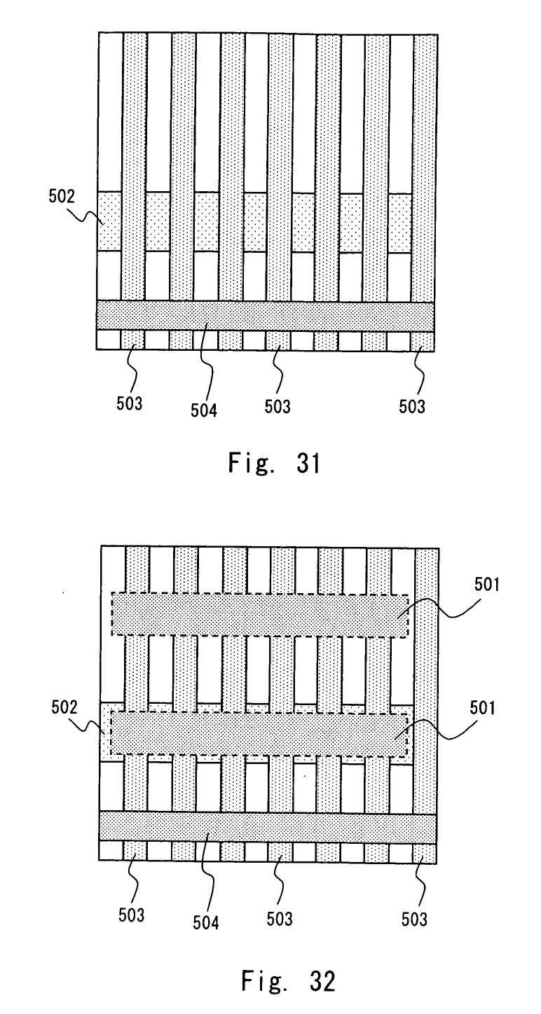

Next, layout design method in the layout design device 300 of the third exemplary embodiment of the present invention will be described with reference to flow charts of FIGS. 25-27. Note that, since the process of steps S201, S203 and S205-S217 are same as steps S101, S103 and S104-S116 shown in FIGS. 17-19, the description is omitted.

In step S202, the calculation processing portion 1A calculates the degree of wire congestion 402 of each layer. Here, the calculation processing portion 1A does not calculate the degree of wire congestion for the area where macro M2 is arranged, and obtains information of the area where the macro M2 is arranged (the area information 411 of the macro positions). The area information 411 of the macro positions is information of the area which is entirely covered with the macro M2. Specifically, as shown in FIG. 28, if the macro M2 protrudes from the areas R20 and R21 a little, the area information 411 of the macro positions is information of the areas R20 and R21.

Further, in step 204, the selection procession portion 2B determines whether the macro M2 is allocated in the selection area (which is selected in step S203).

In step S204, if the selection procession portion 2B determines the macro M2 is allocated in the selection area (which is selected in step S203) (step S204: Yes), the process goes to step S215.

In step S204, if the selection procession portion 2B determines the macro M2 is not allocated in the selection area (which is selected in step S203) (step S204: No), the process goes to the step S205.

As described above, in the layout design device 300 and layout design method according to the third exemplary embodiment of the present invention, the calculation processing portion 1A does not calculate the degree of wire congestion 402 of the selection area of the nth layer 6, if the macro M2 is arranged in the selection area of the nth layer 6. Usually, the design is carried out so as to which meet the criterion of the metal rate in the macro M2. Therefore, according to the third exemplary embodiment, since the calculation processing portion 1A does not calculate the degree of wire congestion 402 of the area where the macro M2 is arranged, this can eliminate unnecessary process and can shorten the process time.

The first, second and third exemplary embodiments can be combined as desirable by one of ordinary skill in the art.

While the invention has been described in terms of several examples of embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A layout design device of a semiconductor integrated device including a plurality of laminated layers in which wires are formed, the layout design device comprising:
a calculation processing portion that calculates a degree of wire congestion of each layer based on a pre-wiring design data to form a desired wiring structure in each layer;
a selection processing portion that selects one area from a plurality of areas as a selection area, the semiconductor device being divided into predetermined areas as the plurality of areas, and when a degree of wire congestion of the selection area of an nth layer (n is an integer number and n=2) is lower than that of an (n−1)th layer, which is a layer below the nth layer, or an (n+1)th layer, which is a layer above the nth layer, the selection processing portion selecting a power supply and ground including layer which is a layer below the (n−1)th layer or a layer above the (n+1)th layer and includes a power supply or a ground; and
an adding processing portion that generates a post-addition design data by adding a design data which connects the power supply and ground including layer and the (n−1)th layer or the (n+1)th layer to the pre-wiring design data,
wherein a wiring process and a metal generating process are performed based on the post-addition design data.

2. The layout design device according to claim 1, wherein
when the degree of wire congestion of the selection area of the nth layer is less than or equal to a first criterion, there is a power supply or a ground in the (n−1)th layer or the (n+1)th layer, and the degree of wire congestion of the (n−1)th layer and the degree of wire congestion of the (n+1)th layer are equal to or more than the second criterion which is more than the first criterion, the selection processing portion determines which is lower of the degree of wire congestion of the selection area of the (n−1)th layer and the degree of wire congestion of the selection area of the (n+1)th layer,
in a case where the selection processing portion determines the degree of wire congestion of the selection area of the (n−1)th layer is lower than that of the (n+1)th layer, the selection processing portion selects a power supply and ground including layer which is the layer below the (n−1)th layer, and
in a case where the selection processing portion determines the degree of wire congestion of the selection area of the(n+1)th layer is lower than that of the (n−1)th layer, the selection processing portion selects a power supply and ground including layer which is the layer above the (n+1)th layer, and
the adding processing portion adds the design data to the pre-wiring design data, the design data comprises data which connects the (n−1)th layer, and the power supply and ground including layer which is the layer above the (n+1)th layer, or connects the (n+1)th layer, and the power supply and ground including layer which is the layer above the (n+1)th layer.

3. The layout design device according to claim 1, wherein the selection processing portion selects the power supply and ground including layer by searching a search scope which has a predetermined size with a central focus on the selection area.

4. The layout design device according to claim 2, wherein the selection processing portion selects the power supply and ground including layer by searching a search scope which is a predetermined size with a central focus on the selection area.

5. The layout design device according to claim 1, wherein the adding processing portion connects the (n−1)th layer or the (n+1)th layer and the power supply and ground including layer by a via, and connects the power supply of the ground and the selection area of the (n−1)th layer or the (n+1)th layer through the via.

6. The layout design device according to claim 2, wherein the adding processing portion connects the (n−1)th layer or the (n+1)th layer and the power supply and ground including layer by a via, and connects the power supply of the ground and the selection area of the (n−1)th layer or the (n+1)th layer through the via.

7. The layout design device according to claim 3, wherein the adding processing portion connects the (n−1)th layer or the (n+1)th layer and the power supply and ground including layer by a via, and connects the power supply of the ground and the selection area of the (n−1)th layer or the (n+1)th layer through the via.

8. The layout design device according to claim 1, wherein, if a macro is arranged in the selection area of the nth layer, the calculation processing portion does not calculate the degree of wire congestion of the selection area of the nth layer.

9. The layout design device according to claim 2, wherein, if a macro is arranged in the selection area of the nth layer, the calculation processing portion does not calculate the degree of wire congestion of the selection area of the nth layer.

10. The layout design device according to claim 3, wherein, if a macro is arranged in the selection area of the nth layer, the calculation processing portion does not calculate the degree of wire congestion of the selection area of the nth layer.

11. The layout design device according to claim 5, wherein, if a macro is arranged in the selection area of the nth layer, the calculation processing portion does not calculate the degree of wire congestion of the selection area of the nth layer.

12. A layout design method of a semiconductor integrated device including a plurality of laminated layers in which wires are formed, the layout design method comprising:
calculating a degree of wire congestion of each layer based on pre-wiring design data to form a desired wiring structure in each layer;
selecting one area from a plurality of areas as a selection area, the semiconductor integrated device being divided into predetermined areas as the plurality of areas, and when a degree of wire congestion of the selection area of an nth layer (n is an integer number and n=2) is lower than that of an (n−1)th layer, which is a layer below the nth layer, or an (n+1)th layer, which is a layer above the nth layer, selecting a power supply and ground including layer which is a layer below the (n−1)th layer or a layer above the (n+1)th layer and includes a power supply or a ground;
generating a post-addition design data by adding a design data which connects the power supply and ground including layer and the (n−1)th layer or the (n+1)th layer to the pre-wiring design data; and
performing a wiring process and a metal generating process based on the post-addition design data.

13. The layout design method according to claim 12, wherein
when the degree of wire congestion of the selection area of the nth layer is less than or equal to a first criterion, there is a power supply or a ground in the (n−1)th layer or the (n+1)th layer, and the degree of wire congestion of the (n−1)th layer and the degree of wire congestion of the (n+1)the layer are equal to or more than the second criterion which is more than the first criterion, the selecting determines which is lower of the degree of wire congestion of the selection area of the (n−1)th layer and the degree of wire congestion of the selection area of the (n+1)th layer,
in a case where the selection processing determines the degree of wire congestion of the selection area of the(n−1)th layer is lower than that of the (n+1)th layer, the selecting selects a power supply and ground including layer which is a layer below the (n−1)th layer, and
in the case where the selection processing determines the degree of wire congestion of the selection area of the(n+1)th layer is lower than that of the (n−1)th layer, the selecting selects a power supply and ground including layer which is a layer above the (n+1)th layer, and
the generating adds the design data to the pre-wiring design data, the design data comprises data which connects the (n−1)th layer, and the power supply and ground including layer which is below the (n−1)th layer, or connects the (n+1)th layer, and the power supply and ground including layer which is above the (n+1)th layer.

14. The layout design method according to claim 12, wherein the selecting selects the power supply and ground including layer by searching a search scope which is a predetermined size with a central focus on the selection area.

15. The layout design method according to claim 13, wherein the selecting selects the power supply and ground including layer by searching a search scope which is a predetermined size with a central focus on the selection area.

16. The layout design method according to claim 12, wherein the generating connects the (n−1)th layer or the (n+1)th layer and the power supply and ground including layer by a via, and connects the power supply of the ground and the selection area of the (n−1)th layer or the (n+1)th layer through the via.

17. The layout design method according to claim 13, wherein the generating connects the (n−1)th layer or the (n+1)th layer and the power supply and ground including layer by a via, and connects the power supply of the ground and the selection area of the (n−1)th layer or the (n+1)th layer through the via.

18. The layout design method according to claim 12, wherein if a macro is arranged in the selection area of the nth layer, the calculating does not calculate the degree of wire congestion of the selection area of the nth layer.

19. The layout design method according to claim 13, wherein if a macro is arranged in the selection area of the nth layer, the calculating does not calculate the degree of wire congestion of the selection area of the nth layer.

20. A computer-readable storage medium tangibly embodied with a computer-readable set of instructions to execute the layout design method of claim 12.
